(19) United States
(12) Patent Application Publication
(10) Pub. No.: US 2025/0317969 A1
(43) Pub. Date: Oct. 9, 2025

(54) CONTENTION-BASED TRANSMISSION OCCASION GROUPING

(71) Applicant: QUALCOMM Incorporated, San Diego, CA (US)

(72) Inventors: Harikumar KRISHNAMURTHY, San Diego, CA (US); Ayan SENGUPTA, San Diego, CA (US); Alberto RICO ALVARINO, San Diego, CA (US); Syed Hashim Ali SHAH, San Diego, CA (US); Bharat SHRESTHA, San Diego, CA (US)

(21) Appl. No.: 19/097,742

(22) Filed: Apr. 1, 2025

Related U.S. Application Data
(60) Provisional application No. 63/574,852, filed on Apr. 4, 2024.

(51) Int. Cl. H04W 74/0816; H04W 24/08; H04W 74/0833

(52) U.S. Cl. CPC H04W 74/0816; H04W 24/08; H04W 74/0833

(57) ABSTRACT

Methods, systems, and devices for wireless communications are described. A user equipment (UE) may receive a configuration for a group of transmission occasions comprising more than one transmission occasion, each transmission occasion in the group of transmission occasions comprising a set of resources shared by a plurality of UEs for contention-based data or access signal transmissions. The UE may perform at least one data or access signal transmission in at least one transmission occasion in the group of transmission occasions and using a resource from the set of resources of the at least one transmission occasion. The UE may monitor for at least one response message based at least in part on the at least one data or access signal transmission.

### CROSS REFERENCE

This patent application claims the benefit of U.S. Provisional Patent Application No. 63/574,852 by KRISHNAMURTHY et al., entitled “CONTENTION-BASED TRANSMISSION OCCASION GROUPING,” filed Apr. 4, 2024, assigned to the assignee hereof, and expressly incorporated by reference herein.

### FIELD OF TECHNOLOGY

The following relates to wireless communications, including contention-based transmission occasion grouping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support contention-based transmission occasion (TO) grouping. For example, the described techniques provide for multiple TOs to be configured for user equipment (UE)(s), with each UE transmitting one or more data or access signals to the network using resources from one or more of the TOs in the group. For example, a UE may receive or otherwise obtain a configuration for a group of TOs. The group of TOs may include multiple TOs, e.g., more than one TO. Each TO in the group may be associated with or otherwise have a set of resources that are shared by a plurality of UEs for contention-based access signal transmissions. The UE may perform at least one data or access signal transmission in at least one TO in the group of TOs using a resource from the set of resources of the at least one TO. The UE may monitor for at least one response message based at least in part on the at least one data or access signal transmission.

A method for wireless communication by a UE is described. The method may include receiving a configuration for a group of TOs including more than one TO, each TO in the group of TOs including a set of resources shared by a set of multiple UEs for contention-based data or access signal transmissions, performing at least one data or access signal transmission in at least one TO in the group of TOs and using a resource from the set of resources of the at least one TO, and monitoring for at least one response message based on the at least one data or access signal transmission.

A UE for wireless communication is described. The UE may include one or more memories storing processor executable code, and one or more processors coupled with the one or more memories. The one or more processors may individually or collectively be operable to execute the code to cause the UE to receive a configuration for a group of TOs including more than one TO, each TO in the group of TOs including a set of resources shared by a set of multiple UEs for contention-based data or access signal transmissions, perform at least one data or access signal transmission in at least one TO in the group of TOs and using a resource from the set of resources of the at least one TO, and monitor for at least one response message based on the at least one data or access signal transmission.

Another UE for wireless communication is described. The UE may include means for receiving a configuration for a group of TOs including more than one TO, each TO in the group of TOs including a set of resources shared by a set of multiple UEs for contention-based data or access signal transmissions, means for performing at least one data or access signal transmission in at least one TO in the group of TOs and using a resource from the set of resources of the at least one TO, and means for monitoring for at least one response message based on the at least one data or access signal transmission.

A non-transitory computer-readable medium storing code for wireless communication is described. The code may include instructions executable by one or more processors to receive a configuration for a group of TOs including more than one TO, each TO in the group of TOs including a set of resources shared by a set of multiple UEs for contention-based data or access signal transmissions, perform at least one data or access signal transmission in at least one TO in the group of TOs and using a resource from the set of resources of the at least one TO, and monitor for at least one response message based on the at least one data or access signal transmission.

In some examples of the method, user equipment (UEs), and non-transitory computer-readable medium described herein, the group of TOs may be associated with at least one of a coverage enhancement level associated with the UE, a number of repetitions to be used for transmission in a TO in the group of TOs, or a transport block size metric associated with the at least one data or access signal transmission from the UE.

Some examples of the method, user equipment (UEs), and non-transitory computer-readable medium described herein may further include operations, features, means, or instructions for receiving an indication of a set of burst sizes associated with the group of TOs, where each burst size in the set of burst sizes identifies a number of TOs in the group of TOs during which the UE may be to perform a data or access signal transmission and selecting a burst size from the set of burst sizes, where a quantity of data or access signal transmissions may be performed during corresponding TOs according to the burst size.

In some examples of the method, user equipment (UEs), and non-transitory computer-readable medium described herein, the UE selects at least one of the corresponding TO according to the burst size, or the resources from the corresponding TOs during which the UE may be to perform data or access signal transmissions, according to a random selection scheme.

In some examples of the method, user equipment (UEs), and non-transitory computer-readable medium described herein, the set of burst sizes includes different burst sizes for a subset of UEs among the set of multiple UEs.

In some examples of the method, user equipment (UEs), and non-transitory computer-readable medium described herein, the set of burst sizes may be specific to a set of multiple groups of TOs including the group of TOs.

Some examples of the method, user equipment (UEs), and non-transitory computer-readable medium described herein may further include operations, features, means, or instructions for receiving an indication of burst size probabilities associated with the set of burst sizes, where the UE selects the burst size from the set of burst sizes according to the burst size probabilities.

Some examples of the method, user equipment (UEs), and non-transitory computer-readable medium described herein may further include operations, features, means, or instructions for receiving an indication of a burst size associated with the group of TOs, where the burst size identifies a quantity of TOs in the group of TOs during which the UE may be to perform a data or access signal transmission.

In some examples of the method, user equipment (UEs), and non-transitory computer-readable medium described herein, the UE selects at least one of the corresponding TO according to the burst size, or the resources from the corresponding TOs during which the UE may be to perform data or access signal transmissions, according to a random selection scheme.

Some examples of the method, user equipment (UEs), and non-transitory computer-readable medium described herein may further include operations, features, means, or instructions for including, in a first data or access signal transmission during a first TO, a first information that identifies a second data or access signal transmission during a second TO.

Some examples of the method, user equipment (UEs), and non-transitory computer-readable medium described herein may further include operations, features, means, or instructions for including, in the second data or access signal transmission during the second TO, a second information that identifies the first data or access signal transmission during the first TO.

In some examples of the method, user equipment (UEs), and non-transitory computer-readable medium described herein, the second information includes at least one of an ordered pair of the at least one TO and resource index for the resource from the set of resources associated with the at least one TO, an index that may be associated with the ordered pair, or a radio network temporary identifier (RNTI) associated with the ordered pair.

In some examples of the method, user equipment (UEs), and non-transitory computer-readable medium described herein, the second information may be indicated in at least one of a medium access control-control element (MAC-CE) or a radio resource control (RRC) message.

In some examples of the method, user equipment (UEs), and non-transitory computer-readable medium described herein, the first information include at least one of an ordered pair of the at least one TO and resource index for the resource from the set of resources associated with the at least one TO, an index that may be associated with the ordered pair, or a RNTI associated with the ordered pair.

In some examples of the method, user equipment (UEs), and non-transitory computer-readable medium described herein, the first information may be indicated in at least one of a MAC-CE or an RRC message.

In some examples of the method, user equipment (UEs), and non-transitory computer-readable medium described herein, monitoring for the at least one response message may include operations, features, means, or instructions for monitoring for a set of multiple response messages associated with multiple access signal transmissions during a corresponding multiple TOs, each response message corresponding to a data or access signal transmission performed during a corresponding TO.

In some examples of the method, user equipment (UEs), and non-transitory computer-readable medium described herein, each response message in the set of multiple response messages may be associated with at least one of a response window or a response timer associated with the corresponding TO.

In some examples of the method, user equipment (UEs), and non-transitory computer-readable medium described herein, monitoring for the at least one response message may include operations, features, means, or instructions for monitoring for a common response message associated with multiple data or access signal transmissions in the group of TOs.

In some examples of the method, user equipment (UEs), and non-transitory computer-readable medium described herein, the common response message may be associated with a response window or a response timer associated with the group of TOs.

Some examples of the method, user equipment (UEs), and non-transitory computer-readable medium described herein may further include operations, features, means, or instructions for determining that the at least one response message was not received during a response window or a response timer and determining the at least one data or access signal transmission to be a failure based on the at least one response message not being received.

In some examples of the method, user equipment (UEs), and non-transitory computer-readable medium described herein, the at least one data or access signal transmission includes at least one of a random-access channel (RACH) preamble transmission, a random access channel (RACH) message A (MsgA) transmission, a RACH-less early data transmission (EDT), a RACH message three (Msg3) transmission with or without a corresponding RACH message one (Msg1) transmission, or a contention-based preconfigured uplink resource (PUR) data transmission.

In some examples of the method, user equipment (UEs), and non-transitory computer-readable medium described herein, the configuration for the group of TOs may be received in at least one of an SIB, or an RRC signal.

### BRIEF DESCRIPTION OF THE DRAWINGS

FIG. 1 shows an example of a wireless communications system that supports contention-based transmission occasion grouping in accordance with one or more aspects of the present disclosure.

FIG. 2 shows an example of a wireless communications system that supports contention-based transmission occasion grouping in accordance with one or more aspects of the present disclosure.

FIG. 3 shows an example of a TO group that supports contention-based transmission occasion grouping in accordance with one or more aspects of the present disclosure.

FIGS. 4 and 5 show block diagrams of devices that support contention-based transmission occasion grouping in accordance with one or more aspects of the present disclosure.

FIG. 6 shows a block diagram of a communications manager that supports contention-based transmission occasion grouping in accordance with one or more aspects of the present disclosure.

FIG. 7 shows a diagram of a system including a device that supports contention-based transmission occasion grouping in accordance with one or more aspects of the present disclosure.

FIGS. 8 through 10 show flowcharts illustrating methods that support contention-based transmission occasion grouping in accordance with one or more aspects of the present disclosure.

### DETAILED DESCRIPTION

Wireless networks may configure physical random-access channel (PRACH) resources during a random-access channel (RACH) occasion (e.g., a transmission occasion for a RACH preamble or data transmission) for a user equipment (UE) to initiate a RACH procedure or to perform a RACH-less early data transmission (EDT) using the PRACH resources in the RACH occasion. The PRACH resources are generally shared resources that are available to any UE wishing to initiate the RACH procedure or to send the EDT to the network. For example, each UE may randomly select one of the PRACH resources (e.g., preambles) to send an access signal to the network according to the PRACH configuration. However, in some examples multiple UE may select the same resource and transmit access signals to the network during the RACH occasion. This may result in a collision of the access signal transmissions, which may introduce delays and disrupt communications between the UE and the network.

Accordingly, the described techniques provide for multiple transmission occasions (TOs) to be configured for UE(s), with each UE transmitting one or more data or access signals to the network using resources from one or more of the TOs in the group. For example, a UE may receive or otherwise obtain a configuration for a group of TOs. The group of TOs may include multiple TOs, e.g., more than one TO. Each TO in the group may be associated with or otherwise have a set of resources that are shared by a plurality of UEs for contention-based access signal transmissions. The UE may perform at least one data or access signal transmission in at least one TO in the group of TOs using a resource from the set of resources of the at least one TO. The UE may monitor for at least one response message based at least in part on the at least one data or access signal transmission.

Aspects of the disclosure are initially described in the context of wireless communications systems. Aspects of the disclosure are further illustrated by and described with reference to apparatus diagrams, system diagrams, and flowcharts that relate to contention-based transmission occasion grouping.

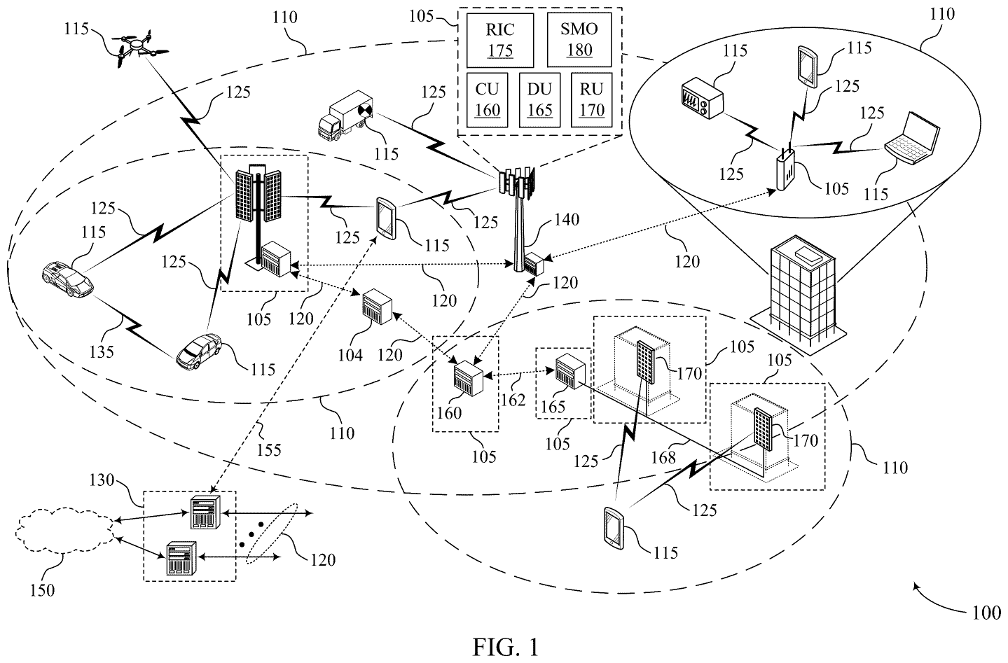

FIG. 1 shows an example of a wireless communications system 100 that supports contention-based transmission occasion grouping in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive a configuration for a group of TOs comprising more than one TO, each TO in the group of TOs comprising a set of resources shared by a plurality of UEs for contention-based data or access signal transmissions. The UE 115 may perform at least one data or access signal transmission in at least one TO in the group of TOs and using a resource from the set of resources of the at least one TO. The UE 115 may monitor for at least one response message based at least in part on the at least one data or access signal transmission.

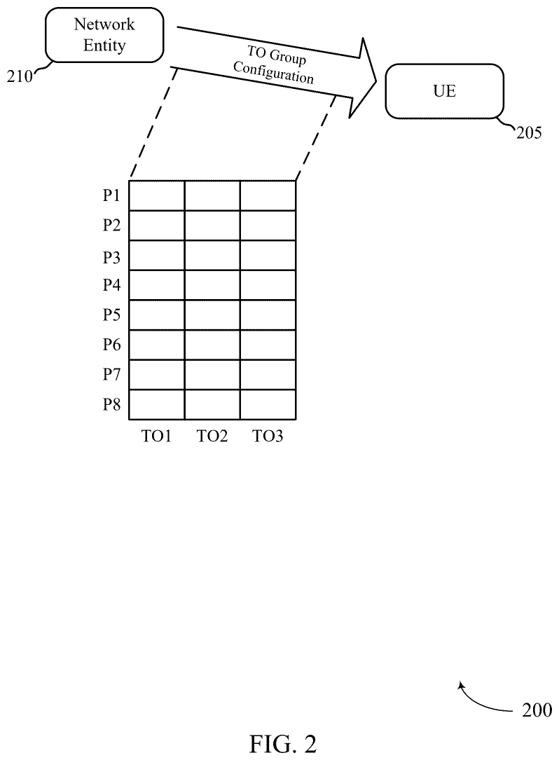

FIG. 2 shows an example of a wireless communications system 200 that supports contention-based TO grouping in accordance with one or more aspects of the present disclosure. Wireless communications system 200 may implement aspects of wireless communications system 100. Wireless communications system 200 may include a UE 205 and a network entity 210, which may be examples of the corresponding devices described herein.

Wireless networks may utilize various access schemes to establish a connection between UE and the network. The access schemes may be contention-based or non-contention-based. The non-contention-based access schemes may include dedicated resources being configured for a UE to establish a connection to the network. The contention-based access schemes may include a pool of resources being established that are shared by all UE.

As one non-limiting example, a contention-based access scheme may include a four-step RACH procedure. The four-step RACH procedure may be initiated with a UE transmitting a message one (Msg1) RACH preamble to the network entity. For example, after choosing a RACH occasion the UE may uniformly and randomly choose a RACH preamble from a set of allowed RACH preambles. The UE may transmit the RACH preamble to the network that is scrambled with a random-access radio network temporary identifier (RA-RNTI). The UE may then wait for a random-access response (RAR) message from the network. In some aspects, the Msg1 transmission may carry or otherwise convey an indication of a random-access preamble identifier (RAPID) associated with the RACH process.

The network may respond to the Msg1 transmission by transmitting the RAR in a message two (Msg2). For example, upon correctly receiving the preamble from the UE the network entity may respond with the RAPID as well as including other information for a message three (Msg3) transmission, such as a timing advance, uplink grant, and temporary cell radio network temporary identifier (C-RNTI). Or the network entity may respond with a backoff indication to let the UE know to abandon the current RACH procedure (e.g., in the situation where the network entity is busy).

The UE may respond to the Msg2 transmission from the network entity by transmitting the Msg3. For example, if the RAR from the network entity includes the RAPID transmitted in the Msg1, the UE may transmit the Msg3 according to the uplink grant indicted in the Msg2. In some aspects, the Msg3 may be scrambled using the temporary C-RNTI and include a contention resolution identifier/C-RNTI (e.g., if the network entity has already assigned a permanent C-RNTI to the UE).

The network entity may correctly receive the Msg3 and resolve any contention, if any. The network entity may transmit a response (e.g., a message four (Msg4)) to the UE that includes the contention resolution identifier/C-RNTI of the successful UE. In some aspects, the network entity may also issue a retransmission of the Msg3 if required. Upon receiving the Msg4 with the matching contention resolution identifier it transmitted in Msg3, the UE may consider the contention resolution and the random-access procedure successful. The UE may then promote the temporary C-RNTI to the permanent C-RNTI (e.g., if not assigned earlier). In some aspects, the UE may transmit an acknowledgement of the Msg4 to the network entity.

However, the contention-based RACH resources are shared by multiple UE, which may result in a collision. For example, Table 1 below shown an example of the contention resources that may be configured according to the traditional four-step RACH procedure. In this example, eight preamble resources (P1-P8) are configured for contention-based RACH procedures that are shared by multiple UE. In the non-limiting example shown in Table 1, a first UE (e.g., UE1) may randomly select a sixth RACH preamble (P6) to transmit its Msg1, a second UE (e.g., UE2) and a fourth UE (e.g., UE4) may randomly select a seventh RACH preamble (P7) to transmit their Msg1, and a third UE (e.g., UE3) may randomly select a first RACH preamble (P1) to transmit its Msg1.

TABLE 1

| | |
|---|---|
| P1 | UE3 |
| P2 | |
| P3 | |
| P4 | |
| P5 | |
| P6 | UE1 |
| P7 | UE2, UE4 |
| P8 | |

Accordingly, Table 1 shows an example where two (or more, in some examples) UE choose the same RACH preamble (e.g., P7, in this example) to transmit their Msg1. For example, both the second UE and the fourth UE transmit identical Msg1 to the network entity. In some examples, the network entity may not be able to correctly receive either Msg1 due to the collision. In other examples, one UE may be associated with a better performing wireless channel such that the network entity is able to receive one Msg1 but not the other Msg1. In this example, the network entity may respond with the Msg2 with the uplink grant information. In this scenario, both UEs would transmit Msg3 in the same uplink grant, each with their own unique contention resolution identifiers. However, the network entity may not be able to decode both Msg3. Again, in some examples the network entity may not be able to decode either Msg3 due to the collision. However, in other examples the network entity may be able to correctly receive the Msg3 from a UE having a better performing wireless channel (e.g., a much larger SINR). In this scenario, initiating a Msg3 retransmission is unhelpful as it would not be UE-specific and, instead, be temporary C-RNTI-specific. So, but UEs would retransmit the Msg3, which would not lead to contention resolution. In the situation where the UE does not receive Msg4 with its identifier within a stipulated window, the UE may need to retry the RACH procedure with the network entity.

Thus, in the example shown in Table 1 the network entity may transmit the RAR with the uplink grant information for the RAPID corresponding to P1, P6, and P7. Each UE may respond with a Msg3 transmission. The network entity may successfully decode the Msg3 from UE1 and UE3 and send their Msg4 with their contention resolution identifiers. However, the Msg3 from UE2 and UE4 will either be undecodable (e.g., due to the collision) or one UE (e.g., the UE with the stronger SINR) out of UE2 or UE4 will be successful and the Msg4 will address that UE's contention resolution identifier.

Another contention-based RACH procedure may include a two-step RACH procedure where Msg1 and Msg3 are combined into a message A (MsgA) and Msg2 and Msg4 are combined into a message B (MsgB). This approach may reduce the latency associated with RACH procedure. However and similar to the four-step RACH procedure, if two or more UEs choose the same preamble they would be involved in a contention and at most one of those UEs would successfully receive a MsgB.

One variation of the two-step RACH procedure may include a RACH-less early data transmission (EDT) being used in NB-IoT communications over a non-terrestrial network (NT). In RACH-less EDT, the UE may directly transmit data in the first transmission (e.g., without preamble) by choosing the data resources (as opposed to preambles too) from a pool of data resources for contention-based transmission. The UE may wait for a response to the data transmission within a time window. This technique may be feasible in NTNs when the UE are GNSS-capable and have location information of the UE and the satellite (e.g., from the satellite ephemeris). However, even in this situation the collision discussed above may be applicable. That is, if two or more UEs choose the same data resource (e.g., corresponding to the preamble resource discussed above) for transmission of the RACH-less EDT, there will likely be a collision at the network entity and the random access will fail (e.g., the RACH-less EDT transmission will fail).

For example, and continuing with the example shown in Table 1, the network entity may send a response (e.g., the MsgB or an acknowledgment to the RACH-less EDT) corresponding to the data resources (e.g., which would be designated D1, D6, and D7 corresponding to P1, P6, and P7 from Table 1) with unique contention resolution identifiers for UE1 and UE3. However, for the data resource D7, the network entity cannot detect (e.g., absent a large difference in SINR between UE2 and UE4)) the transmission. Accordingly, the network entity may not be able to detect the unique contention resolution identifier from either UE2 or UE4. For both UE2 and UE4, the contention resolution will fail and each UE would need to restart the RACH procedure after waiting for the response window time. However, NTNs are generally associated with a large round-trip time (RTT) or round-trip delay (RTD). In this aspect, the response time window for Msg2, Msg4, MsgB, or a response to RACH-less EDT is generally quite large. This may result in large delays when the UE is not successful in completing the RACH procedure on the first try (e.g., such as in the case of a collision, as discussed above). Accordingly, it would be beneficial to reduce the probability of collisions to reduce the probability of failure of the RACH procedure and, therefore, the large delays that a collision entails (e.g., such as in an NTN).

In some wireless networks, the default scheme for random-access in a slotted ALOHA method. In this method, the wireless channel may be divided into small, fixed-length time slots or blocks of time and the UE are only allowed to transmit data at the beginning of each time slot or time block. For example, each UE may pick a preamble (or a data resource for RACH-less EDT) from a set of preambles (or a pool of data resources) uniformly and randomly. However, if more than one UE picks the same preamble (or data resources), there is a collision at that preamble (or data resource) and all UEs transmitting that preamble (or on that data resource) fail the random-access/data transmission. For example, each UE will either collide in the Msg3 transmission (for preamble-based four-step RACH) or will not receive a contention resolution success indication (e.g., an acknowledgement) in response to the preamble or the data (e.g., in RACH-less EDT) transmission.

Accordingly, aspects of the techniques described herein provide for a diversity slotted ALOHA (DSA) approach to minimize the chances of collisions between multiple UE. Generally, this may include grouping TOs together where each UE may transmit at least one or more than one access signal (e.g., Msg1, Msg3, with or without a corresponding Msg1, MsgA, or data in RACH-less EDT) to the network entity. For example, and as is shown in FIG. 2. this may include a group of TOs having three TOs (e.g., TO1, TO2, and TO3), in this example. Generally, each TO may include a time slot or block of time during which any UE may transmit the data or access signals to the network entity. Each TO may include a single time slot or time block during which the access signal transmissions may occur or may include multiple time slots or time blocks (e.g., for repetition-based access signal transmissions). Each time slot or time block may span one or more symbols, one or more slots, or one or more radio frames.

This may include the network configuring the UE 205 with the group of TOs. For example, the network entity 210 may transmit or otherwise provide (and the UE 205 may receive or otherwise obtain) a configuration for a group of TOs that include more than one TO (e.g., three TOs, in this non-limiting example). In some examples, the configuration may be for multiple groups of TOs. For example, each group of TOs may have similar TOs (e.g., the same number and configuration of TOs) or may have different TOs (e.g., a different number or configuration of TOs). In some aspects, the UE 205 may receive or otherwise obtain the configuration for the group(s) of TOs via a system information block (SIB) or via RRC signaling from the network entity 210.

Each TO in the group of TOs may include a set of resources shared by a plurality of UEs for contention-based data or access signal transmissions. In this non-limiting example, the set of resources available during each TO includes eight RACH preamble resources (P1-P8). However, in the example where the data or access signal transmissions are for RACH-less EDT, the set of resources may include data resources (e.g., D1-D8). Generally, each resource in the set of resources may include time resources, frequency resources, spatial resources, or code resources that are to be used by UE selecting that resource for data or access signal transmission to the network entity 210.

In this example, the group of TOs may include N TOs (e.g., N=3 in this example) that make up the TO group. Each TO may generally include a set of resources (e.g., preamble resources, such as P1-P8, or data resources, such as in RACH-less EDT) that are shared by a plurality of UE for contention-based data or access signal transmissions. In some aspects, the group of TOs may be formed based on or otherwise associated with a coverage enhancement level associated with the UE, a number of repetitions to be used for transmission in a TO, or a transport block size (TBS) metric associate with at least one data or access signal transmission from the UE. The coverage enhancement level associated with a UE may be dependent on or based on, for example, a received downlink signal quality at the UE. This may be determined based on a reference signal receive power (RSRP) level or a reference signal received quality (RSRQ) level. This may be expressed in terms of the number of repetitions that are configured for transmission (e.g., UEs with a poorer RSRP may select resources from a coverage enhancement level pool which is configured with a larger number of repetitions, than would a UE with a higher RSRP value). In some aspects, this may include one group of TOs being configured with UE for a first coverage enhancement level and a different group of TOs being configured for UE with a second (e.g., different) coverage enhancement level (e.g., multiple groups of TOs).

With regards to the TBS, if the UE wants to use or is configured to use a low TBS, it may pick a resource (e.g., TO) from a resource pool (e.g., from a group of TOs or from a different group of TOs) with fewer repetitions. For a transmission with a larger TBS, the UE may select a resource from a resource pool with a larger number of repetitions.

Accordingly, this may include the UE being provided through SIB or other signaling, the grouping of TOs into TO groups within which a UE performs burst transmissions. The configuration can be specified per coverage enhancement level or per TBS. The group(s) of TOs may be contiguous or noncontiguous and may be disjointed or have at least partial overlap across groups.

In some aspects, this may include the UE 205 receiving or otherwise obtaining (and the network entity 210 transmitting or otherwise outputting) an indication of a burst size associated with the group of TOs. The burst size may identify a quantity of TOs in the group of TOs during which the UE 205 is to perform data or access signal transmission. For example, a burst size (e.g., k) may also be configured that generally defines the number of TO(s) in the group(s) of TOs during which the UE are to perform access signal transmissions. In one non-limiting example, the burst size is set to two (e.g., k=2) such that each UE is expected to perform two data or access signal transmissions during two TOs in the group of TOs. Accordingly, each UE may choose two out of the three TOs in the group and choose a preamble resource (e.g., P1-P8, in this example) or a data resource (e.g., D1-D8 in RACH-less EDT) in each TO for the data or access signal transmission. Each UE may independently and randomly select the preamble resource or data resource from more than one TO in the group of TOs. That is, in each of the k TOs the UE would pick a resource from the available resources independently and randomly to use to transmit the at least one data or access signal transmission.

Aspects of the described techniques may also provide for an irregular repetition slotted ALOHA (e.g., IRSA) approach. In this approach, the UE 205 may choose a burs size k from an available list of burst sizes (e.g., according to a burst size probability). For example, the network entity 210 may transmit or otherwise output (and the UE 205 may receive or otherwise obtain) an indication of a set of burst sizes associated with the group(s) of TOs. Each burst size (e.g., k) in the set of burst sizes may identify the number of TO(s) in the group(s) of TOs during which the UE is to perform a data or access signal transmission. The UE 205, in this example, may select a burst size from the set of burst sizes. The quantity of data or access signal transmission may be performed during the corresponding TOs according to the burst size. That is, if the UE 205 chooses a burst size of two (e.g., k=2), the quantity of data or access signal transmissions may be two transmissions performed during two TOs. In another example where the UE 205 chooses a burst size of six (e.g., k=6), the UE 205 may perform six data or access signal transmissions during six TOs from the group of TOs. Accordingly, N TOs may be grouped into a TO group and the UE 205 may choose k of the N TOs in the group to transmit data or access signal transmissions. In each of these k TOs, the UE 205 may select or otherwise choose a resource (e.g., any of P1-P8, or D1-D8 for RACH-less EDT) from the available resources independently and randomly (e.g., according to a random selection scheme) and performs the data or access signal transmission in or using the selected resource.

In some aspects, the set of burst sizes may include different burst sizes for different UEs (e.g., a subset of UEs in the plurality of UEs). For example, the configuration for the set of burst sizes may be specified per-coverage enhancement level or per TBS associated with each UE. In some aspects, the set of burst sizes may be specified as common for all TO groups or may be specified for each TO group separately or specified commonly for sets of TO groups. That is, the set of burst sizes may include a common burst size for all TOs in the group of TOs, as a unique burst size for each TO in the group of TOs, or as a same burst size for multiple groups of TOs. That is, the set of burst sizes associated with a first group of TOs may be different from a set of burst sizes associate with a second group of TOs.

In some aspects, this may include the UE 205 selecting or otherwise picking the TO (e.g., uniformly at random) after selecting a burst size. As one non-limiting example, the UE 205 may include the exact TO(s) to transmit in (e.g., if k=2 and N=6, then UE 205 may randomly pick TO1 and TO4) independently and uniformly at random. The exact resource within a TO (e.g., if there are 48 resources l in a TO) may be selected by the UE 205 randomly (e.g., the UE 205 may randomly select resources number 17 from the 48 resources in the TO). This approach may be applied for both the DSA approach or the IRSA approach discussed above (e.g., the UE 205 selects the TO(s) randomly and then randomly selects a resource from the TO to transmit the data or access signal transmission).

Accordingly, in some aspects, the burst size may be provided as a single entry (e.g., the same burst sizes for all UEs), such as according to the DSA approach discussed above, or may be a list of burst sizes from which the UE samples the burst size for the current TO group, such as according to the IRSA approach discussed above. Each burst size may correspond to an integer that is equal to or larger than one. In some aspects, the UE may be configured or otherwise provided with the burst size configuration through SIB or other signaling.

In some aspects, a bursting size probability may be associated with the burst size. For example, the network entity 210 may transmit or otherwise output (and the UE 205 may receive or otherwise obtain) an indication of burst size probabilities associated with the set of burst sizes. The UE 205 may choose or otherwise select the burst size from the set of burst sizes according to the burst size probability. For example, the UE 205 may be configured or otherwise provided (e.g., via SSB signaling or other signaling means) with the indication of the probabilities with which the burst size for the current group of TOs is sampled from the burst size list (e.g., as previously indicated). The configuration for the burst size probabilities may be specified per coverage enhancement level of the UE or per TBS of the associated data or access signal transmission(s). For example, an optional field containing a list of a same length as the set of burst sizes whose entries are in the interval [0, 1] and add up to one.

As one non-limiting example, the group of TOs may include eight TOs (e.g., N=8) and the burst size set (e.g., the set of burst sizes) associated with the group of TOS are configured as [1, 2, 4, 6]. The burst size probabilities for the corresponding burst sizes in this example may be configured as [0.5, 0.25, 0.125, 0.125]. The UE 205 may choose a burst size of TO 1 using a weighting point of 0.5, of TO 2 using a weighting point 0.25, of TO 4 using a weighting point of 0.125, or of TO 4 using a weighting point of 0.125. That is, the UE 205 may select from the set of burst sizes according to the burst size probabilities indicated to the UE 205 for the group of TOs. In the example where the burst size probabilities are not specified for the UE 205, the UE 205 may select a burst size from the set of burst sizes according to a (pre)defined distribution, such as a discrete uniform distribution.

Accordingly, the UE 205 may perform at least one data or access signal transmission in at least one TO in the group of TOs. For example, the UE 205 may use a resource from the set of resources of the at least one TO. More particularly, the UE 205 may be configured with N TOs in the group of TOs, select the burst size k indicating how many TOs in the group of TOs the UE 205 will use, and then select a resource l from each of the k TOs to use to perform the data or access signal transmissions. In some aspects, the UE 205 may perform these selections randomly (e.g., according to a random selection scheme).

In some aspects, the at least one data or access signal transmission may also be referred to as a burst. For example, the burst may include multiple copies of the same information conveyed in each data or access signal transmission from the UE 205. Examples of the types of messages may be conveyed in the at least one data or access signal transmission include, but are not limited to, a RACH preamble transmission, a RACH MsgA, a RACH-less EDT, a RACH Msg3 transmission (e.g., with or without a corresponding RACH Msg1 transmission) or a contention-based preconfigured uplink resources (PUR) data transmission.

In some aspects, the described techniques may further provide for contention resolution DSA (e.g., CRDSA). For example, the burst size may be fixed (e.g., according to DSA) or the UE 205 may select the burst size from the set of burst sizes (e.g., IRSA), such as according to the probability distribution when configured. N transmission occasions are grouped into a TO group and the UE 205 may choose k of the TOs to transmit in. In this CRDSA example and where k is two or more, the UE 205 may include or otherwise convey an indication of a reference to the other data or access signal transmissions that it has transmitted in. This approach may enable the network entity 210, upon successfully decoding at least one copy of the burst by the UE 205 (e.g., the data or access signal transmission in one TO), to remove interference from the other copies in the burst to enable decoding of other UEs whose transmissions have collided in those resources and TO pair. This interference cancellation followed by decoding may be repeated multiple times by the network entity 210.

For example, the UE 205 may include or otherwise convey a first information in a first data or access transmission during a first TO. The first information may carry or otherwise convey information that identifies a second data or access signal transmission that was performed during a second TO. In some examples, the UE 205 may include or otherwise convey a second information in the second data or access transmission during the second TO. The second information, in this example, may carry or otherwise convey information that identifies the first data or access signal transmission that was performed during the first TO. That is, to easily and effectively perform interference cancellation, the network entity 210 may know the location or contents of the other data or access signal transmissions within the burst for a corresponding UE. The data or preamble carried by each copy within a burst from the same UE may be the same. That is, the at least one data or access signal transmission during k TOs of the group of N TOs may be copies of each other in each TO (e.g., the same information is transmitted in each TO from a UE). The UE 205 may communicate (e.g., within one or each copy) the location of the other copies within the burst. In some aspects, this information may be communicated in a MAC-CE or in an RRC message. In some aspects, this information may be embedded in the transmission using a last of the {TO, resource}pair of each copy of the burst in a predefined order or can be a reference to a row in a lookup table or can be a list of temporary C-RNTI (TC-RNTI).

That is, the first information or the second information may include at least one of an ordered pair of the at least one TO and resource index for the resource (e.g., l) from the set of resources associated with the at least one TO, an index that is associated with an ordered pair, or a RNTI (e.g., the TC-RNTI) associated with the ordered pair. The ordered pair may generally refer to the k TO from the group of TOs that the UE 205 has used to transmit a data or access signal transmission and an index to the resource from the set of resources associated with that TO.

The UE 205 may then monitor for at least one response message based on the at least one data or access signal transmission. In some aspects, the response from the network entity 210 may be a separate response for each TO or may be a combined response for a group of TOs. Which option to choose may be configured or otherwise indicated to the UE 205 via SIB or other signaling means (e.g., in RRC signaling).

For example, in some aspects, the UE 205 may monitor for a plurality of response messages associated with multiple data or access signal transmission during a corresponding multiple TOs. Each response message, in this example, may correspond to a data or access signal transmission perform during a corresponding TO. In some aspects, each response message in the plurality of response messages may be associated with a response window or a response timer associated with the corresponding TO (e.g., per-TO response windows or response timers). That is, the UE may continue to monitor for a response for each TO it has transmitted in (e.g., within a TO group) using separate response windows or response timers for each of the TOs.

In another example, a combined response message may be used by the network entity 210. For example, the UE 205 may monitor for a common response message associated with multiple data or access signal transmissions in the group of TOs. In this example, the common response message may be associated with a response window or a response timer associated with the group of TOs (e.g., per-TO group response window or response timer). The UE 205 may monitor for the response with a response window that is defined from the end of the TO group (e.g., instead of from the end of a TO). The UE 205 may use a single response window or response timer for the common response message.

In some aspects, the success of the at least one data or access signal transmission may be based on at least one resource (e.g., TO and resource pair) in which the UE 205 transmits not colliding with a transmission from another UE. However, if the UE 205 does not receive or otherwise obtain a response for any of the transmissions in a burst, the UE 205 may be configured to declare a failure and retry the transmission procedure or continue with an updated set of transmission parameters (e.g., a fewer number of transmissions in the burst). For example, the UE 205 may identify or otherwise determine that the at least one response message was not received during a response window or response timer. Accordingly, the UE 205 may identify or otherwise determine that the at least one data or access signal transmission to be a failure based on the at least one response message not being received.

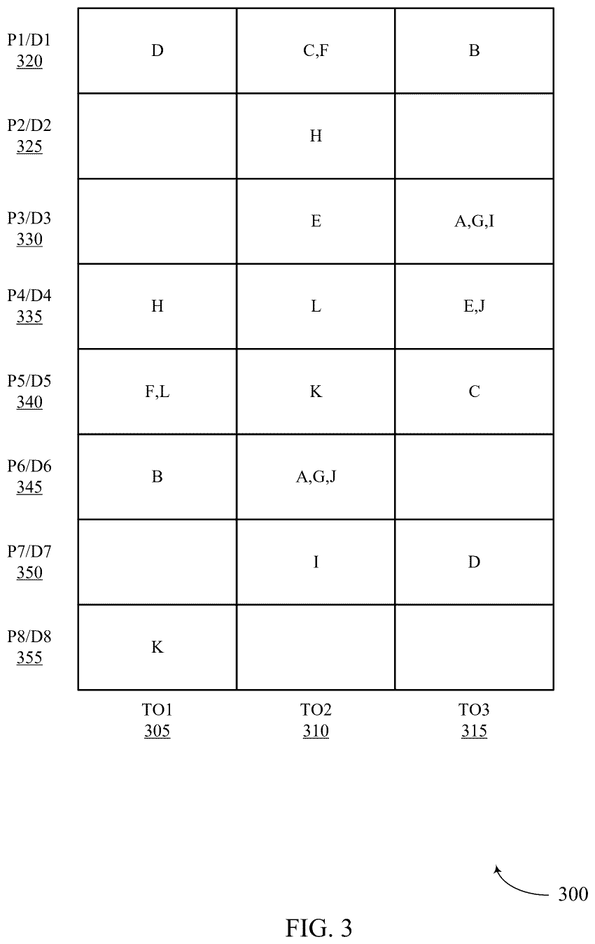

FIG. 3 shows an example of a TO group 300 that supports contention-based transmission occasion grouping in accordance with one or more aspects of the present disclosure. TO group 300 may implement aspects of wireless communications system 100 or wireless communications system 200. Aspects of TO group 300 may be implemented at or implemented by a UE or a network entity, which may be examples of the corresponding devices described herein.

As discussed above, aspects of the describe techniques may include grouping multiple (e.g., more than one) TOs into a group of TOs. For example, a UE may receive a configuration for a group of TOs where each TO in the group of TOs includes a set of resources that are shared by a plurality of UEs for contention-based data or access signal transmissions. The UE may perform at least one data or access signal transmission in at least one TO in the group of TOs using a resource from the set of resources of the at least one TO. The UE may monitor for at least one response message based on the at least one data or access signal transmission.

In the non-limiting example shown in FIG. 3, the group of TOs includes three TOs (e.g., a first TO 305, a second TO 310, and a third TO 315). However, it is to be understood that the group of TOs may include more than three TOs or may include fewer than three TOs (e.g., two TOs). Further, each TO in the group of TOs has an associated set of resources. In this non-limiting example, the set of resources for each TO includes eight resources. For example, each TO in the group of TOs is associated with a first preamble or data resource 320, a second preamble or data resource 325, a third preamble or data resource 330, a fourth preamble or data resource 335, a fifth preamble or data resource 340, a sixth preamble or data resource 345, a seventh preamble or data resource 350, and an eighth preamble or data resource 355. That is, each resource in set of resources may correspond to a preamble resource (e.g., for use during a RACH procedure) or a data resource (e.g., for use during RACH-less EDT).

In the non-liming example shown in FIG. 3, twelve UEs (e.g., UE-A through UE-L) use the group of TOs to perform at least one data or access signal transmission. In this non-limiting example, each of the twelve UEs selects a burst size of two such that each UE performs a burst during two of the three TOs in the group of TOs. For example, and during the first TO 305, a UE-D selects the first preamble or data resource 320, the UE-H selects the fourth preamble or data resource 335, both UE-F and UE-L select the fifth preamble or data resource 340, the UE-B selects the sixth preamble or data resource 345, and the UE-K selects the eighth preamble or data resource 355 to perform their respective data or access signal transmission. During the second TO 310, both UE-C and UE-F select the first preamble or data resource 320, the UE-H selects the second preamble or data resource 325, the UE-E selects the third preamble or data resource 330, the UE-L selects the fourth preamble or data resource 335, the UE-K selects the fifth preamble or data resource 340, each of the UE-A, UE-G, and UE-J select the sixth preamble or data resource 345, and the UE-I selects the seventh preamble or data resource 350 to perform their respective data or access signal transmission. During the third TO 315, the UE-B selects the first TO 305, each of the UE-A, UE-G, and UE-I select the third preamble or data resource 330, both of the UE-E and UE-J select the fourth preamble or data resource 335, the UE-C selects the fifth preamble or data resource 340, and the UE-D selects the seventh preamble or data resource 350 to perform their respective data or access signal transmission. As noted, in this non-limiting example each UE has selected a burst size of two (e.g., k=2) such that each UE performs a data or access signal transmission during two TOs in the group of TOs.

As can be seen, this results in collisions occurring between some of the UEs. For example, UE-F and UE-L have colliding transmissions during the first TO 305 using the fifth preamble or data resource 340. UE-C and UE-F have colliding transmissions during the second TO 310 using the first preamble or data resource 320 and UE-A, UE-G, and UE-J have colliding transmissions using the sixth preamble or data resource 345. Similarly, UE-A, UE-G, and UE-I have colliding transmissions during the third TO 315 using the third preamble or data resource 330 and UE-E and UE-J have colliding transmissions using the fourth preamble or data resource 335.

In some examples, UEs having a successful data or access signal transmission may include UE-B, UE-C, UE-D, UE-E, UE-H, UE-I, UE-K and UE-L since each UE has at least one non-colliding transmission out of the two transmissions within the group of TOs. For example, although each of the UE-C, UE-E, UE-I, and UE-L have one colliding transmission, each UE has also selected a resource within at least one TO to perform its data or access signal transmission during at least one TO in the group of TOs. For example, the UE-L has a colliding transmission during the first TO 305 but does not have a colliding transmission during the second TO 310. Similarly, the UE-C has a colliding transmission during the second TO 310 but its transmission during the third TO 315 does not collide with any other UE transmission(s). Accordingly, each UE in this example may have a successful data or access signal transmission using the techniques described herein. That is, the chance of the data or access signal transmission being successful is increased using the TO grouping techniques describe herein.

Furthermore, in some aspects some or all of the UEs using the group of TOs may indicate first information and, in some examples, the second information in each data or access signal transmission that points to the other transmission. In this example, the network entity may use interference cancellation to achieve greater success in successfully decoding the colliding data or access signal transmissions. For example, using interference cancellation based on the first and second information may result in UE-F and UE-L having successful data or access signal transmissions. For example, the network entity may use interference cancellation to remove the interference from UE-L during the first TO 305 to recover the transmission from UE-F. Similarly, the network entity may use interference cancellation to remove the interference from UE-E during the third TO 315 to recover the transmission from UE-J. Accordingly, the successful UEs after one-step interference cancellation may now include the UE-B, UE-C, UE-D, UE-E-, UE-F, UE-H, UE-I, UE-J, UE-K, and UE-L.

Each of UE-A and UE-G may have unsuccessful data or access signal transmissions due to both transmission from these UEs colliding with multiple UEs.

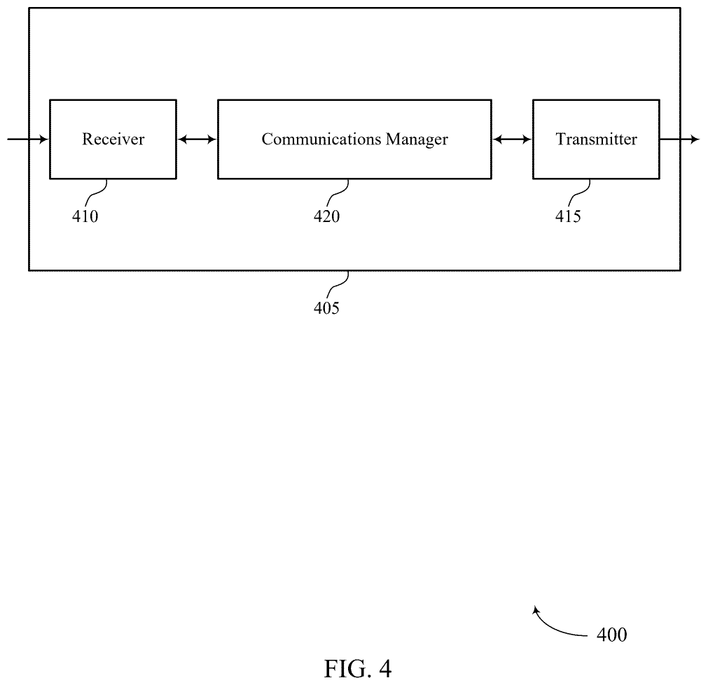

FIG. 4 shows a block diagram 400 of a device 405 that supports contention-based TO grouping in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to contention-based TO grouping). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to contention-based TO grouping). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of contention-based TO grouping as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for receiving a configuration for a group of TOs including more than one TO, each TO in the group of TOs including a set of resources shared by a set of multiple UEs for contention-based data or access signal transmissions. The communications manager 420 is capable of, configured to, or operable to support a means for performing at least one data or access signal transmission in at least one TO in the group of TOs and using a resource from the set of resources of the at least one TO. The communications manager 420 is capable of, configured to, or operable to support a means for monitoring for at least one response message based on the at least one data or access signal transmission.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for grouping of TOs into a TO group to enable improved data or access signal transmissions from UEs by minimizing collisions.

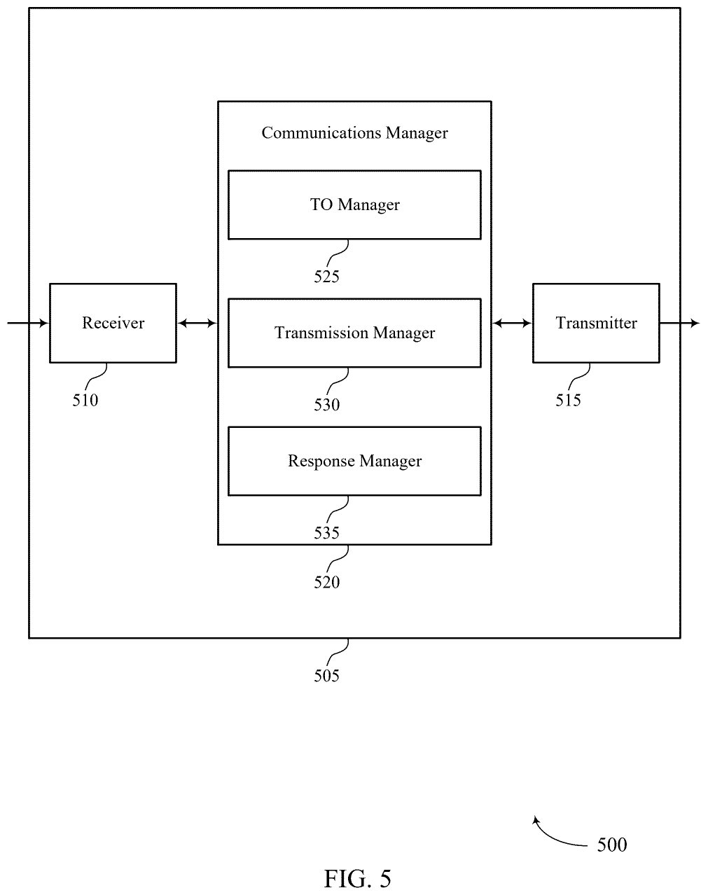

FIG. 5 shows a block diagram 500 of a device 505 that supports contention-based TO grouping in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to contention-based TO grouping). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to contention-based TO grouping). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of contention-based TO grouping as described herein. For example, the communications manager 520 may include a TO manager 525, a transmission manager 530, a response manager 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The TO manager 525 is capable of, configured to, or operable to support a means for receiving a configuration for a group of TOs including more than one TO, each TO in the group of TOs including a set of resources shared by a set of multiple UEs for contention-based data or access signal transmissions. The transmission manager 530 is capable of, configured to, or operable to support a means for performing at least one data or access signal transmission in at least one TO in the group of TOs and using a resource from the set of resources of the at least one TO. The response manager 535 is capable of, configured to, or operable to support a means for monitoring for at least one response message based on the at least one data or access signal transmission.

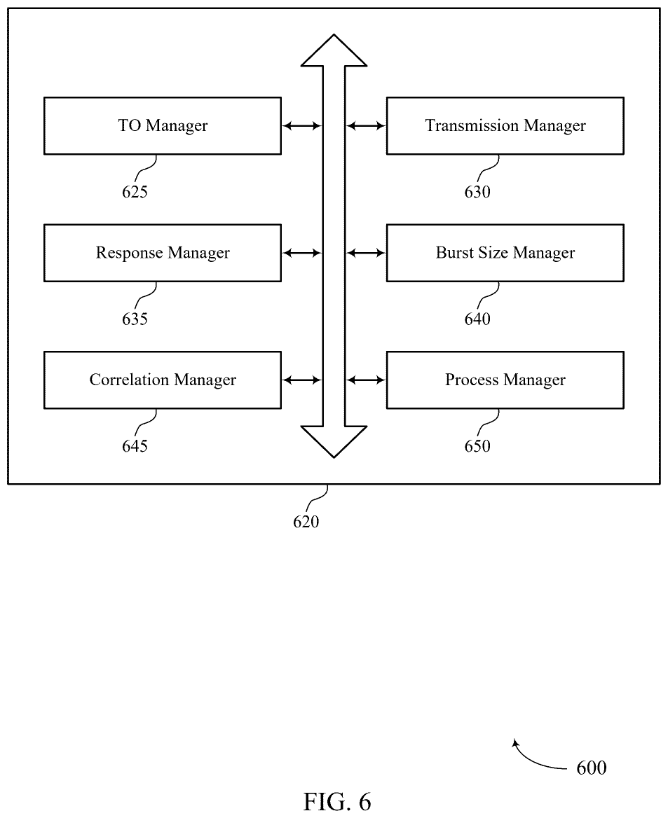

FIG. 6 shows a block diagram 600 of a communications manager 620 that supports contention-based TO grouping in accordance with one or more aspects of the present disclosure. The communications manager 620 may be an example of aspects of a communications manager 420, a communications manager 520, or both, as described herein. The communications manager 620, or various components thereof, may be an example of means for performing various aspects of contention-based TO grouping as described herein. For example, the communications manager 620 may include a TO manager 625, a transmission manager 630, a response manager 635, a burst size manager 640, a correlation manager 645, a process manager 650, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The TO manager 625 is capable of, configured to, or operable to support a means for receiving a configuration for a group of TOs including more than one TO, each TO in the group of TOs including a set of resources shared by a set of multiple UEs for contention-based data or access signal transmissions. The transmission manager 630 is capable of, configured to, or operable to support a means for performing at least one data or access signal transmission in at least one TO in the group of TOs and using a resource from the set of resources of the at least one TO. The response manager 635 is capable of, configured to, or operable to support a means for monitoring for at least one response message based on the at least one data or access signal transmission.

In some examples, the group of TOs is associated with at least one of a coverage enhancement level associated with the UE, a number of repetitions to be used for transmission in a TO in the group of TOs, or a transport block size metric associated with the at least one data or access signal transmission from the UE.

In some examples, the burst size manager 640 is capable of, configured to, or operable to support a means for receiving an indication of a set of burst sizes associated with the group of TOs, where each burst size in the set of burst sizes identifies a number of TOs in the group of TOs during which the UE is to perform a data or access signal transmission. In some examples, the burst size manager 640 is capable of, configured to, or operable to support a means for selecting a burst size from the set of burst sizes, where a quantity of data or access signal transmissions are performed during corresponding TOs according to the burst size. In some examples, the UE selects at least one of the corresponding TO according to the burst size, or the resources from the corresponding TOs during which the UE is to perform data or access signal transmissions, according to a random selection scheme.

In some examples, the set of burst sizes includes different burst sizes for a subset of UEs among the set of multiple UEs. In some examples, the set of burst sizes is specific to a plurality of groups of TOs including the group of TOs.

In some examples, the burst size manager 640 is capable of, configured to, or operable to support a means for receiving an indication of burst size probabilities associated with the set of burst sizes, where the UE selects the burst size from the set of burst sizes according to the burst size probabilities. In some examples, the burst size manager 640 is capable of, configured to, or operable to support a means for receiving an indication of a burst size associated with the group of TOs, where the burst size identifies a quantity of TOs in the group of TOs during which the UE is to perform a data or access signal transmission. In some examples, the UE selects at least one of the corresponding TO according to the burst size or the corresponding TOs during which the UE is to perform data or access signal transmissions according to a random selection scheme.

In some examples, the correlation manager 645 is capable of, configured to, or operable to support a means for including, in a first data or access signal transmission during a first TO, a first information that identifies a second data or access signal transmission during a second TO. In some examples, the first information includes at least one of an ordered pair of the at least one TO and resource index for the resource from the set of resources associated with the at least one TO, an index that is associated with the ordered pair, or a RNTI associated with the ordered pair. In some examples, the first information is indicated in at least one of a MAC-CE or a RRC message.

In some examples, the correlation manager 645 is capable of, configured to, or operable to support a means for including, in the second data or access signal transmission during the second TO, a second information that identifies the first data or access signal transmission during the first TO. In some examples, the second information includes at least one of an ordered pair of the at least one TO and resource index for the resource from the set of resources associated with the at least one TO, an index that is associated with the ordered pair, or a RNTI associated with the ordered pair. In some examples, the second information is indicated in at least one of a MAC-CE or an RRC message.

In some examples, to support monitoring for the at least one response message, the response manager 635 is capable of, configured to, or operable to support a means for monitoring for a set of multiple response messages associated with multiple access signal transmissions during a corresponding multiple TOs, each response message corresponding to a data or access signal transmission performed during a corresponding TO. In some examples, each response message in the set of multiple response messages is associated with at least one of a response window or a response timer associated with the corresponding TO.

In some examples, to support monitoring for the at least one response message, the response manager 635 is capable of, configured to, or operable to support a means for monitoring for a common response message associated with multiple data or access signal transmissions in the group of TOs. In some examples, the common response message is associated with a response window or a response timer associated with the group of TOs.

In some examples, the process manager 650 is capable of, configured to, or operable to support a means for determining that the at least one response message was not received during a response window or a response timer. In some examples, the process manager 650 is capable of, configured to, or operable to support a means for determining the at least one data or access signal transmission to be a failure based on the at least one response message not being received. In some examples, the at least one data or access signal transmission includes at least one of a RACH preamble transmission, a RACH MsgA transmission, a RACH-less EDT, a RACH Msg3 transmission with or without a corresponding RACH Msg1 transmission, or a contention-based PUR data transmission. In some examples, the configuration for the group of TOs is received in at least one of an SIB, or an RRC signal.

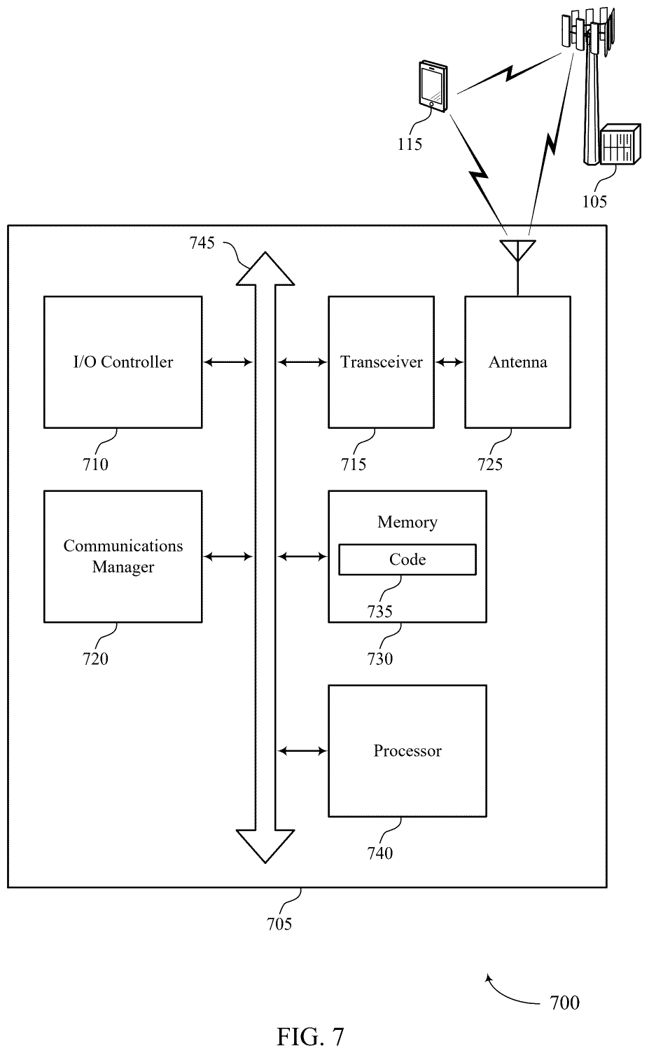

FIG. 7 shows a diagram of a system 700 including a device 705 that supports contention-based TO grouping in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting contention-based TO grouping). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for receiving a configuration for a group of TOs including more than one TO, each TO in the group of TOs including a set of resources shared by a set of multiple UEs for contention-based data or access signal transmissions. The communications manager 720 is capable of, configured to, or operable to support a means for performing at least one data or access signal transmission in at least one TO in the group of TOs and using a resource from the set of resources of the at least one TO. The communications manager 720 is capable of, configured to, or operable to support a means for monitoring for at least one response message based on the at least one data or access signal transmission.

By including or configuring the communications manager 720 in accordance with examples as described herein, the device 705 may support techniques for grouping of TOs into a TO group to enable improved data or access signal transmissions from UEs by minimizing collisions.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of contention-based TO grouping as described herein, or the at least one processor 740 and the at least one memory 730 may be otherwise configured to, individually or collectively, perform or support such operations.

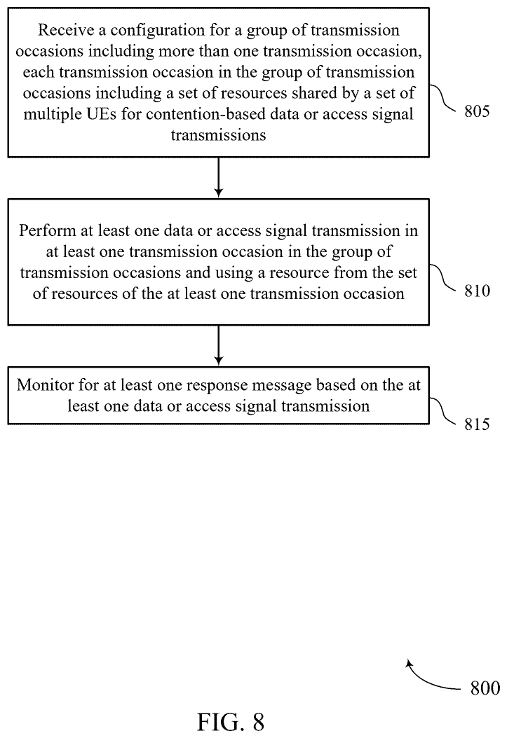

FIG. 8 shows a flowchart illustrating a method 800 that supports contention-based TO grouping in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving a configuration for a group of TOs including more than one TO, each TO in the group of TOs including a set of resources shared by a set of multiple UEs for contention-based data or access signal transmissions. The operations of 805 may be performed in accordance with examples as disclosed herein. In some examples, aspects of the operations of 805 may be performed by a TO manager 625 as described with reference to FIG. 6.

At 810, the method may include performing at least one data or access signal transmission in at least one TO in the group of TOs and using a resource from the set of resources of the at least one TO. The operations of 810 may be performed in accordance with examples as disclosed herein. In some examples, aspects of the operations of 810 may be performed by a transmission manager 630 as described with reference to FIG. 6.

At 815, the method may include monitoring for at least one response message based on the at least one data or access signal transmission. The operations of 815 may be performed in accordance with examples as disclosed herein. In some examples, aspects of the operations of 815 may be performed by a response manager 635 as described with reference to FIG. 6.

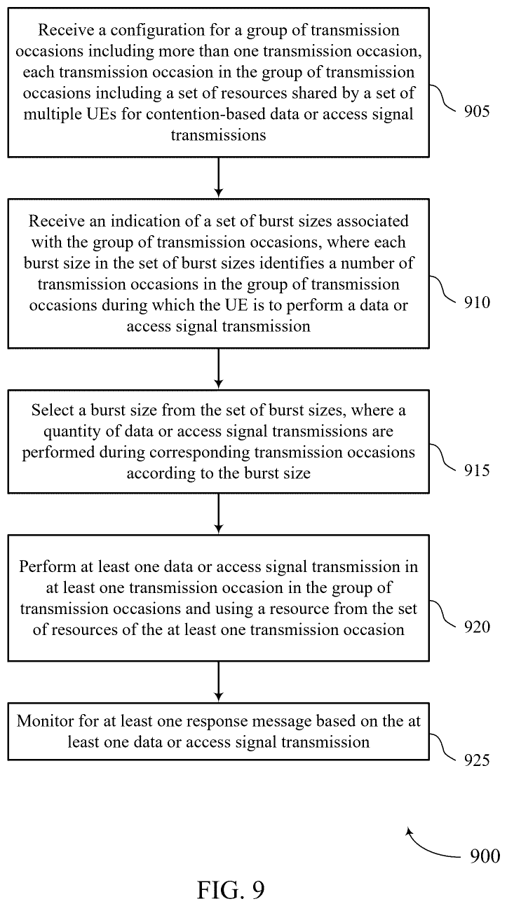

FIG. 9 shows a flowchart illustrating a method 900 that supports contention-based TO grouping in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving a configuration for a group of TOs including more than one TO, each TO in the group of TOs including a set of resources shared by a set of multiple UEs for contention-based data or access signal transmissions. The operations of 905 may be performed in accordance with examples as disclosed herein. In some examples, aspects of the operations of 905 may be performed by a TO manager 625 as described with reference to FIG. 6.

At 910, the method may include receiving an indication of a set of burst sizes associated with the group of TOs, where each burst size in the set of burst sizes identifies a number of TOs in the group of TOs during which the UE is to perform a data or access signal transmission. The operations of 910 may be performed in accordance with examples as disclosed herein. In some examples, aspects of the operations of 910 may be performed by a burst size manager 640 as described with reference to FIG. 6.

At 915, the method may include selecting a burst size from the set of burst sizes, where a quantity of data or access signal transmissions are performed during corresponding TOs according to the burst size. The operations of 915 may be performed in accordance with examples as disclosed herein. In some examples, aspects of the operations of 915 may be performed by a burst size manager 640 as described with reference to FIG. 6.

At 920, the method may include performing at least one data or access signal transmission in at least one TO in the group of TOs and using a resource from the set of resources of the at least one TO. The operations of 920 may be performed in accordance with examples as disclosed herein. In some examples, aspects of the operations of 920 may be performed by a transmission manager 630 as described with reference to FIG. 6.

At 925, the method may include monitoring for at least one response message based on the at least one data or access signal transmission. The operations of 925 may be performed in accordance with examples as disclosed herein. In some examples, aspects of the operations of 925 may be performed by a response manager 635 as described with reference to FIG. 6.

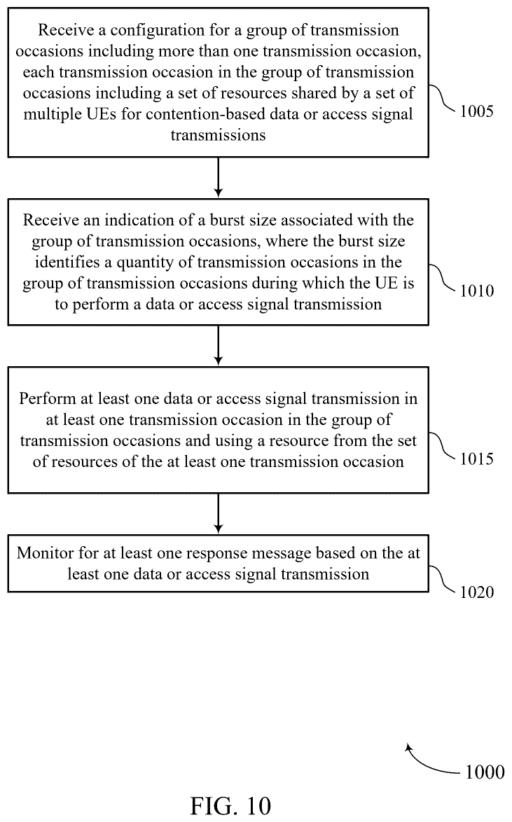

FIG. 10 shows a flowchart illustrating a method 1000 that supports contention-based TO grouping in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving a configuration for a group of TOs including more than one TO, each TO in the group of TOs including a set of resources shared by a set of multiple UEs for contention-based data or access signal transmissions. The operations of 1005 may be performed in accordance with examples as disclosed herein. In some examples, aspects of the operations of 1005 may be performed by a TO manager 625 as described with reference to FIG. 6.

At 1010, the method may include receiving an indication of a burst size associated with the group of TOs, where the burst size identifies a quantity of TOs in the group of TOs during which the UE is to perform a data or access signal transmission. The operations of 1010 may be performed in accordance with examples as disclosed herein. In some examples, aspects of the operations of 1010 may be performed by a burst size manager 640 as described with reference to FIG. 6.

At 1015, the method may include performing at least one data or access signal transmission in at least one TO in the group of TOs and using a resource from the set of resources of the at least one TO. The operations of 1015 may be performed in accordance with examples as disclosed herein. In some examples, aspects of the operations of 1015 may be performed by a transmission manager 630 as described with reference to FIG. 6.

At 1020, the method may include monitoring for at least one response message based on the at least one data or access signal transmission. The operations of 1020 may be performed in accordance with examples as disclosed herein. In some examples, aspects of the operations of 1020 may be performed by a response manager 635 as described with reference to FIG. 6.

The following provides an overview of aspects of the present disclosure:

Aspect 1: A method for wireless communication at a UE, comprising: receiving a configuration for a group of TOs comprising more than one TO, each TO in the group of TOs comprising a set of resources shared by a plurality of UEs for contention-based data or access signal transmissions; performing at least one data or access signal transmission in at least one TO in the group of TOs and using a resource from the set of resources of the at least one TO; and monitoring for at least one response message based at least in part on the at least one data or access signal transmission.

Aspect 2: The method of aspect 1, wherein the group of TOs is associated with at least one of a coverage enhancement level associated with the UE, a number of repetitions to be used for transmission in a TO in the group of TOs, or a transport block size metric associated with the at least one data or access signal transmission from the UE.

Aspect 3: The method of any of aspects 1 through 2, further comprising: receiving an indication of a set of burst sizes associated with the group of TOs, wherein each burst size in the set of burst sizes identifies a number of TOs in the group of TOs during which the UE is to perform a data or access signal transmission; and selecting a burst size from the set of burst sizes, wherein a quantity of data or access signal transmissions are performed during corresponding TOs according to the burst size.

Aspect 4: The method of aspect 3, wherein the UE selects at least one of the corresponding TO according to the burst size, or the resources from the corresponding TOs during which the UE is to perform data or access signal transmissions, according to a random selection scheme.

Aspect 5: The method of any of aspects 3 through 4, wherein the set of burst sizes comprises different burst sizes for a subset of UEs among the plurality of UEs.

Aspect 6: The method of any of aspects 3 through 5, wherein the set of burst sizes is specific to a plurality of groups of TOs including the group of TOs.

Aspect 7: The method of any of aspects 3 through 6, further comprising: receiving an indication of burst size probabilities associated with the set of burst sizes, wherein the UE selects the burst size from the set of burst sizes according to the burst size probabilities.

Aspect 8: The method of any of aspects 3 through 7, wherein the UE selects at least one of the corresponding TO according to the burst size, or the resources from the corresponding TOs during which the UE is to perform data or access signal transmissions, according to a random selection scheme.

Aspect 9: The method of any of aspects 1 through 7, further comprising: receiving an indication of a burst size associated with the group of TOs, wherein the burst size identifies a quantity of TOs in the group of TOs during which the UE is to perform a data or access signal transmission.

Aspect 10: The method of any of aspects 1 through 9, further comprising: including, in a first data or access signal transmission during a first TO, a first information that identifies a second data or access signal transmission during a second TO.

Aspect 11: The method of aspect 10, further comprising: including, in the second data or access signal transmission during the second TO, a second information that identifies the first data or access signal transmission during the first TO.

Aspect 12: The method of aspect 11, wherein the second information comprises at least one of an ordered pair of the at least one TO and resource index for the resource from the set of resources associated with the at least one TO, an index that is associated with the ordered pair, or a RNTI associated with the ordered pair.

Aspect 13: The method of any of aspects 11 through 12, wherein the second information is indicated in at least one of a MAC-CE or an RRC message.

Aspect 14: The method of any of aspects 10 through 13, wherein the first information comprise at least one of an ordered pair of the at least one TO and resource index for the resource from the set of resources associated with the at least one TO, an index that is associated with the ordered pair, or a RNTI associated with the ordered pair.

Aspect 15: The method of any of aspects 10 through 14, wherein the first information is indicated in at least one of a MAC-CE or an RRC message.

Aspect 16: The method of any of aspects 1 through 15, wherein monitoring for the at least one response message comprises: monitoring for a plurality of response messages associated with multiple access signal transmissions during a corresponding multiple TOs, each response message corresponding to a data or access signal transmission performed during a corresponding TO.

Aspect 17: The method of aspect 16, wherein each response message in the plurality of response messages is associated with at least one of a response window or a response timer associated with the corresponding TO.

Aspect 18: The method of any of aspects 1 through 17, wherein monitoring for the at least one response message comprises: monitoring for a common response message associated with multiple data or access signal transmissions in the group of TOs.

Aspect 19: The method of aspect 18, wherein the common response message is associated with a response window or a response timer associated with the group of TOs.

Aspect 20: The method of any of aspects 1 through 19, further comprising: determining that the at least one response message was not received during a response window or a response timer; and determining the at least one data or access signal transmission to be a failure based at least in part on the at least one response message not being received.

Aspect 21: The method of any of aspects 1 through 20, wherein the at least one data or access signal transmission comprises at least one of a RACH preamble transmission, a RACH MsgA transmission, a RACH-less EDT, a RACH Msg3 transmission with or without a corresponding RACH Msg1 transmission, or a contention-based PUR data transmission.

Aspect 22: The method of any of aspects 1 through 21, wherein the configuration for the group of TOs is received in at least one of an SIB, or an RRC signal.

Aspect 23: A UE for wireless communication, comprising one or more memories storing processor-executable code, and one or more processors coupled with the one or more memories and individually or collectively operable to execute the code to cause the UE to perform a method of any of aspects 1 through 22.

Aspect 24: A UE for wireless communication, comprising at least one means for performing a method of any of aspects 1 through 22.

Aspect 25: A non-transitory computer-readable medium storing code for wireless communication, the code comprising instructions executable by one or more processors to perform a method of any of aspects 1 through 22.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a configuration for a group of transmission occasions comprising more than one transmission occasion, each transmission occasion in the group of transmission occasions comprising a set of resources shared by a plurality of UEs for contention-based data or access signal transmissions;
perform at least one data or access signal transmission in at least one transmission occasion in the group of transmission occasions and using a resource from the set of resources of the at least one transmission occasion; and
monitor for at least one response message based at least in part on the at least one data or access signal transmission.

2. The UE of claim 1, wherein the group of transmission occasions is associated with at least one of a coverage enhancement level associated with the UE, a number of repetitions to be used for transmission in a transmission occasion in the group of transmission occasions, or a transport block size metric associated with the at least one data or access signal transmission from the UE.

3. The UE of claim 1, wherein the one or more processors are individually or collectively further operable to execute the code to cause the UE to:
receive an indication of a set of burst sizes associated with the group of transmission occasions, wherein each burst size in the set of burst sizes identifies a number of transmission occasions in the group of transmission occasions during which the UE is to perform a data or access signal transmission; and
select a burst size from the set of burst sizes, wherein a quantity of data or access signal transmissions are performed during corresponding transmission occasions according to the burst size.

4. The UE of claim 3, wherein the UE selects at least one of the corresponding transmission occasions according to the burst size, or the resource from the set of resources of the corresponding transmission occasions during which the UE is to perform data or access signal transmissions, according to a random selection scheme.

5. The UE of claim 3, wherein the set of burst sizes comprises different burst sizes for a subset of UEs among the plurality of UEs.

6. The UE of claim 3, wherein the set of burst sizes is specific to a plurality of groups of transmission occasions including the group of transmission occasions.

7. The UE of claim 3, wherein the one or more processors are individually or collectively further operable to execute the code to cause the UE to:
receive an indication of burst size probabilities associated with the set of burst sizes, wherein the UE selects the burst size from the set of burst sizes according to the burst size probabilities.

8. The UE of claim 3, wherein the UE selects at least one of the corresponding transmission occasions according to the burst size, or the resource from the set of resources of the corresponding transmission occasions during which the UE is to perform data or access signal transmissions, according to a random selection scheme.

9. The UE of claim 1, wherein the one or more processors are individually or collectively further operable to execute the code to cause the UE to:
receive an indication of a burst size associated with the group of transmission occasions, wherein the burst size identifies a quantity of transmission occasions in the group of transmission occasions during which the UE is to perform a data or access signal transmission.

10. The UE of claim 1, wherein the one or more processors are individually or collectively further operable to execute the code to cause the UE to:
include, in a first data or access signal transmission during a first transmission occasion, a first information that identifies a second data or access signal transmission during a second transmission occasion.

11. The UE of claim 10, wherein the first information comprise at least one of an ordered pair of the at least one transmission occasion and resource index for the resource from the set of resources associated with the at least one transmission occasion, an index that is associated with the ordered pair, or a radio network temporary identifier (RNTI) associated with the ordered pair.

12. The UE of claim 10, wherein the first information is indicated in at least one of a medium access control-control element (MAC-CE) or a radio resource control (RRC) message.

13. The UE of claim 10, wherein the one or more processors are individually or collectively further operable to execute the code to cause the UE to:
include, in the second data or access signal transmission during the second transmission occasion, a second information that identifies the first data or access signal transmission during the first transmission occasion.

14. The UE of claim 13, wherein the second information comprise at least one of an ordered pair of the at least one transmission occasion and resource index for the resource from the set of resources associated with the at least one transmission occasion, an index that is associated with the ordered pair, or a radio network temporary identifier (RNTI) associated with the ordered pair.

15. The UE of claim 13, wherein the second information is indicated in at least one of a medium access control-control element (MAC-CE) or a radio resource control (RRC) message.

16. The UE of claim 1, wherein, to monitor for the at least one response message, the one or more processors are individually or collectively operable to execute the code to cause the UE to:
monitor for a plurality of response messages associated with multiple access signal transmissions during a corresponding multiple transmission occasions, each response message corresponding to a data or access signal transmission performed during a corresponding transmission occasion.

17. The UE of claim 16, wherein each response message in the plurality of response messages is associated with at least one of a response window or a response timer associated with the corresponding transmission occasion.

18. The UE of claim 1, wherein, to monitor for the at least one response message, the one or more processors are individually or collectively operable to execute the code to cause the UE to:
monitor for a common response message associated with multiple data or access signal transmissions in the group of transmission occasions.

19. A method for wireless communication at a user equipment (UE), comprising:
receiving a configuration for a group of transmission occasions comprising more than one transmission occasion, each transmission occasion in the group of transmission occasions comprising a set of resources shared by a plurality of UEs for contention-based data or access signal transmissions;
performing at least one data or access signal transmission in at least one transmission occasion in the group of transmission occasions and using a resource from the set of resources of the at least one transmission occasion; and
monitoring for at least one response message based at least in part on the at least one data or access signal transmission.

20. A non-transitory computer-readable medium storing code for wireless communication, the code comprising instructions executable by one or more processors to:
receive a configuration for a group of transmission occasions comprising more than one transmission occasion, each transmission occasion in the group of transmission occasions comprising a set of resources shared by a plurality of UEs for contention-based data or access signal transmissions;
perform at least one data or access signal transmission in at least one transmission occasion in the group of transmission occasions and using a resource from the set of resources of the at least one transmission occasion; and
monitor for at least one response message based at least in part on the at least one data or access signal transmission.
